(19) United States
(12) Patent Application Publication
(10) Pub. No.: US 2008/0272720 A1
(43) Pub. Date: Nov. 6, 2008

(54) ACCURATE MOTOR SPEED CONTROL

(75) Inventor: Marvin L. Kausch, Mountain View, CA (US)

Correspondence Address: SCHWEGMAN, LUNDBERG & WOESSNER / ATMEL, P.O. BOX 2938, MINNEAPOLIS, MN, 55402, US

(73) Assignee: ATMEL CORPORATION, San Jose, CA (US)

(21) Appl. No.: 11/743,940

(22) Filed: May 3, 2007

(51) Int. Cl. H02P 6/06; H02P 7/29

(52) U.S. Cl. 318/400.17

(57) ABSTRACT

A method of and system for controlling a brushless direct current (BLDC) motor includes providing with a lookup table a predetermined corresponding desired revolution time (DRT) for the BLDC motor for an ambient temperature. A Hall device is used to measure an actual revolution time (RT) of the BLDC motor. DRT and RT are compared to change duration of a pulse width modulation (PWM) signal in response to the comparison result. The PWM signal is applied to one of two BLDC motor windings.

### TECHNICAL FIELD

The present invention relates to a motor control device and, more particularly, to a motor control device that provides accurate regulation of motor speed.

### BACKGROUND ART

Low-cost brushless DC (BLDC) motors are used to drive cooling fans for various types of electronic systems, such as, for example personal computers. BLDC motors have permanent magnets mounted to a rotor and two or more commutated stator windings through which current is passed to provide electric fields for driving the rotor. A Hall effect sensor is used to magnetic fields to the permanent magnets on the rotor to thereby provide information about the location and movement of the rotor to which a fan structure is attached. It is desirable that the speed of the cooling fan be adjusted relative to ambient temperature to provide sufficient cooling for an electronic system. Many of the BLDC motors for cooling fans are operated open-loop and have poor speed control.

### SUMMARY OF THE INVENTION

A method of controlling a brushless direct current (BLDC) motor includes providing with a lookup table a predetermined corresponding desired revolutions per minute for the BLDC motor for an ambient temperature. A Hall device is used to measure an actual revolution time (RT) of the BLDC motor. DRT and RT are compared so that the duration of a pulse width modulation (PWM) signal is changed in response to the comparison result. The PWM signal is applied to one of two BLDC motor windings.

A method of controlling a brushless direct current (BLDC) motor includes reading a VT voltage corresponding to an ambient temperature; using a digitized VT voltage to enter a lookup table that provides a desired RPM value for each digitized VT voltage value to match the speed of the BDLC motor to a particular ambient temperature represented by the VT signal; calculating a desired revolution time (DRT) of a rotor of the BLDC motor for a particular ambient temperature value by dividing a constant value by the desired RPM value; measuring the time for one complete actual revolution (RT) of the rotor of the BLDC motor by measuring the time for two Hall device output pulses; comparing the desired revolution time (DRT) with the time for one complete actual revolution (RT), such that: if RT>DRT, decrementing the value of a control signal sent to a PWM circuit; if RT<DRT, incrementing the value of the control signal sent to the PWM circuit; if RT=DRT, not updating the value of the control signal sent to the PWM circuit 128 of the controller 102; commutating an appropriate BDLC motor winding using motor position information provided by the Hall sensor; applying a PWM signal to either a first driver circuit for the first stator winding or a second driver circuit for the second stator winding; and applying a PWM signal to either a first driver circuit for the first stator winding or a second driver circuit for the second stator winding.

A brushless BLDC motor system includes first and second driver circuits for respective first and second stator winding of the motor. A Hall device provides output signals corresponding to rotation of the motor. A controller receives and ambient temperature signal and the output signals of the Hall device. The controller provides pulse width modulated signals to the respective first and second stator winding of the motor. The width of the pulse width modulated signals are controlled to match a desired speed of the motor to the ambient temperature signal

A brushless direct current (BLDC) motor system includes a BLDC motor having a rotor with permanent magnets mounted thereto and having a stator with a first stator winding and a second stator winding. A first driver circuit for the first stator winding and a second driver circuit for the second stator winding are provided. A Hall device that is fixed to the stator and that is configured to be activated by magnetic fields from the permanent magnets mounted to the rotor provides Hall output pulses at an output terminal thereof. A controller is provided that has a Hall pulse input terminal configured to receive the Hall output pulses, that has a VT input terminal configured to receive a signal from a sensor for ambient temperature, that has a pulse width modulation (PWM) circuit for providing PWM signals to the first and the second driver circuits; and that has a commutator circuit for selecting either the first stator winding or the second stator winding. The controller is configured to digitize the VT voltage corresponding to an ambient temperature and to use a lookup table to provide a desired RPM value for each digitized VT voltage value in order to match the speed of the BDLC motor to a particular ambient temperature represented by the VT signal. The controller is configured to calculate a desired revolution time (DRT) for a particular ambient temperature value by dividing a constant value by the desired RPM value. The controller is configured to measure an actual time for one complete actual revolution (RT) of the rotor by measuring a time for two Hall device output pulses.

The controller is configured to compare the desired revolution time (DRT) with the time for one complete actual revolution (RT) such that: if RT>DRT, the controller is configured to decrement the value of a control signal sent to the PWM circuit; if RT<DRT, the controller is configured to increment the value of the control signal sent to the PWM circuit; and if RT=DRT, the controller is configured to not update the value of the control signal sent to the PWM circuit. The controller is configured to commutate an appropriate BDLC motor winding using motor position information provided by the Hall sensor using either the first driver circuit for the first stator winding or the second driver circuit for the second stator winding.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a circuit diagram of a BLDC motor system that includes a controller that receives input signals from a Hall device and that provides output pulse width modulated PWM signals to stator windings of a BLDC motor.

FIG. 2 is a flow chart illustrating one embodiment of an algorithm for controlling the speed of a BLDC motor.

FIG. 3 is a flow chart illustrating another embodiment of an algorithm for controlling the speed of a BLDC motor.

### DETAILED DESCRIPTION

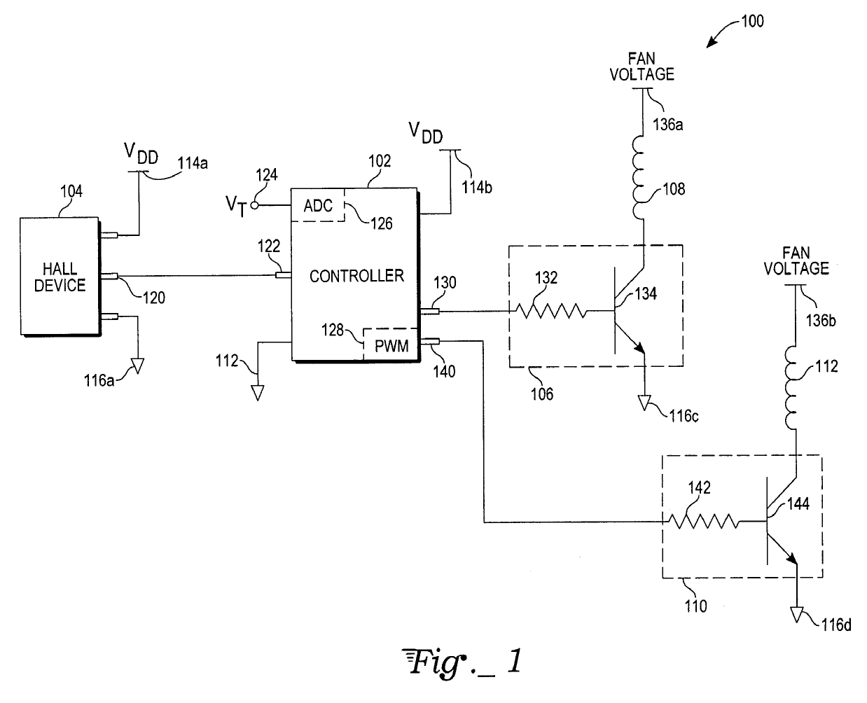

FIG. 1 illustrates an exemplary embodiment of a BLDC motor system 100 that includes a controller 102 that receives input signals from a Hall device 104 and that provides output pulse width modulated PWM signals to a first driver circuit 106 for a first stator winding 108 of a BLDC motor and to a second driver circuit 110 for a second stator winding 112 of the BLDC motor.

The exemplary Hall device 104 includes a Hall effect sensor element (not shown) and additional circuitry (not shown) to provide current and voltage sensing. The Hall device 104 is coupled to a VDD voltage supply terminal 114a and a ground terminal 116a. An output terminal 120 of the Hall device 104 is coupled to an input terminal 122 of the controller 102.

The controller 102 is implemented, for example, as a microcontroller such as, for example, an 8-bit AVR microcontroller, such as the ATtiny13 provided by Atmel Corporation of San Jose, Calif. The controller 102 is coupled to a VDD voltage supply terminal 114b and a ground terminal 116b. A VT input terminal 124 of the controller 102 receives a voltage signal from a sensor (not shown) for ambient temperature. The VT input terminal 124 is coupled to an analog-to-digital (ADC) circuit 126 of the controller 102.

A pulse width modulation (PWM) circuit 128 of the controller 102 has a first output terminal 130 that is coupled to one end of a first series input resistor 132 in the first driver circuit 106. A second end of the first series input resistor 132 is coupled to a base of a first NPN driver transistor 134. An emitter of the first NPN driver transistor 134 is coupled to a ground terminal 116c. A collector of the first NPN driver transistor 134 is coupled to a first end of a first stator winding 108. A second end of the first stator winding 108 is coupled to a fan positive voltage terminal 136a.

Similarly, the pulse width modulation (PWM) circuit 128 of the controller 102 has a second output terminal 140 that is coupled to one end of a second series input resistor 142 in the second driver circuit 110. A second end of the second series input resistor 142 is coupled to a base of a second NPN driver transistor 144. An emitter of the second NPN driver circuit 110 is coupled to a ground terminal 116d. A collector of the second NPN driver transistor 144 is coupled to a first end of the second stator winding 112. A second end of the second stator winding 112 is coupled to a fan positive voltage terminal 136b. The first stator winding 108 provides one phase of the BLDC motor (not shown). The second stator winding 112 provides a second phase of the BLDC motor.

The BLDC motor has permanent magnets mounted to a rotor. Current is switched, or commutated, through the first and second stator windings 108, 112 to provide electric fields for driving the rotor. The Hall effect sensor 104 detects proximity of the magnetic fields from the permanent magnets on the rotor to thereby provide information about the location and movement of the rotor to which a fan structure is attached. During rotation of the rotor, the magnetic fields of the rotor magnets pass by the Hall elements of the Hall device 104. Each magnetic field creates a Hall voltage pulse at the output terminal 120 of the Hall device 104. For each rotation of a two-phase BLDC motor, two Hall voltage pulses are produced by the Hall device 104 at the output pin 120 of the Hall device 104. The Hall voltage output pulse is used by the controller 102 in a commutation cycle for the BLDC motor. During a first part of the BLDC motor commutation cycle, the Hall voltage pulse at terminal 120 switches between 0 volts and the VDD voltage at the VDD voltage supply terminal 114a in response to detection of variations in the field provided by the rotor permanent magnets. The Hall voltage pulses in combination with programming of the controller 102 provide commutation for controlling the BDLC motor speed.

The exemplary controller 102 includes a 4.8 MHz internal oscillator (not shown) that is counted down to provide a clock signal with a 60 microsecond clock period. Times are measured by counting reference clock signals. In one embodiment, the BLDC motor rotates one revolution in 10 milliseconds. One Hall pulse occurs every 5 milliseconds. At its maximum speed, the BLDC motor has PWM pulses at the controller 102 output terminals 130, 140 with a 50% duty cycle. For slower speeds, the BLDC motor has PWM pulses with duty cycles less than 50%.

The exemplary commutation scheme uses a change in a Hall voltage pulse to trigger an interrupt routine in the controller 102. The interrupt routine interrogates a timer that has been counting up since a last change in the Hall voltage pulse. According to how much time has elapsed since the last change in Hall voltage pulse, and taking into account the rising or falling transition of the present change in the Hall voltage pulse, the controller 102 provides winding control signals at the terminals 130, 140. The winding control signals are coupled to respective driver circuits 106, 110 where they produce a base voltage at the respective base terminals of the first and second NPN driver transistors 134, 144. Variations in the duration of base voltage on the NPN driver transistors 134, 144 vary the amount of current conducted through the respective stator windings 108, 112 to modulate the magnetic fields in the windings controlling the respective phases of the brushless DC motor. By varying the timing and duration of the PWM signals, the controller 102 maintains or changes the fan speed.

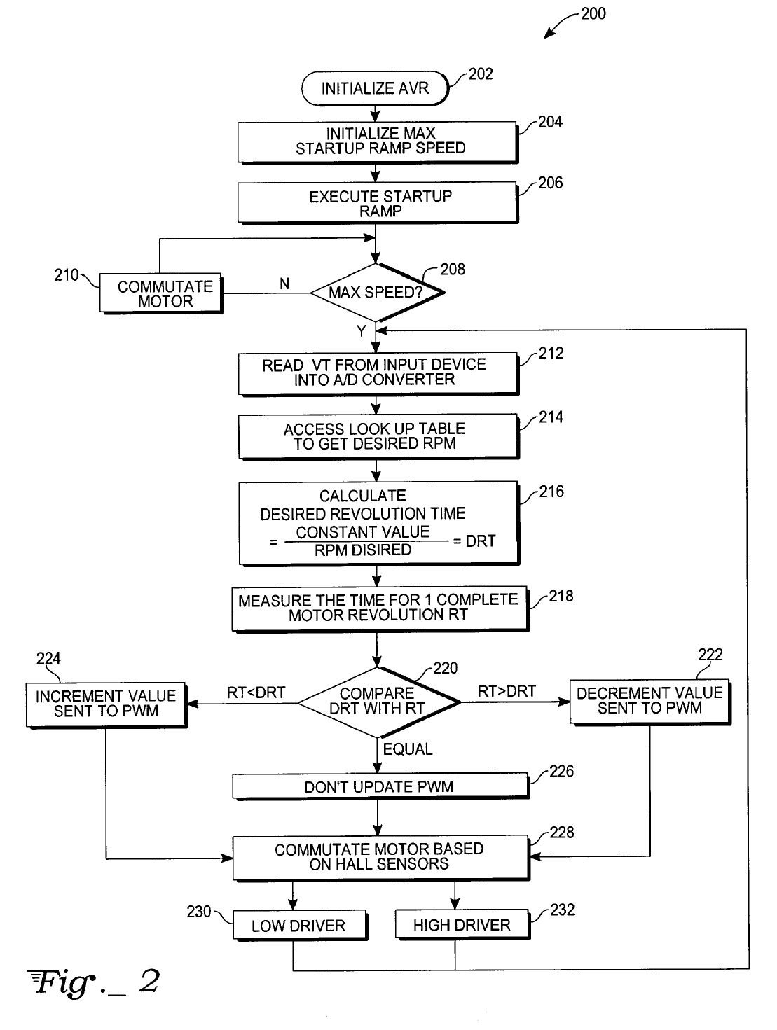

FIG. 2 illustrates a flow chart 200 for one embodiment of an algorithm illustrating various steps for controlling the speed of the BLDC motor system of FIG. 1. In step 202, the controller, such as the exemplary AVR microcontroller, is initialized. In step 204, the maximum startup ramp speed is initialized; and in step 206, the algorithm executes a startup ramp for the BLDC motor. A decision step 208 determines whether the maximum startup speed has been reached. If the maximum startup speed has not been reached, step 210 calls for commutating the BLDC motor and returning to the decision block 208. If the maximum startup speed has been reached, in step 212 the analog-to-digital ADC circuit 126 of the controller 102 reads the VT voltage at terminal 124 corresponding to an ambient temperature. In step 214, the controller uses the digitized VT voltage to enter a lookup table that provides a desired RPM value for each digitized VT voltage value. The lookup table is used to match the speed of the BLDC motor to a particular ambient temperature represented by the VT signal. In step 216, the controller calculates a desired revolution time (DRT) for a particular ambient temperature value by dividing a constant value by the desired RPM value of step 214. The constant value is based on motor characteristics. As an example, at 6000 RPM, the desired rotation time (DRT) is 0.01 seconds and the constant equals 60.

Alternatively, the time for one half of a revolution can be used. This charges the value of the constant. The same performance is obtained. In step 218, the controller measures the time for one complete actual revolution (RT) of the rotor by measuring the time for two Hall device output pulses. A 3-way decision step 220 compares the desired revolution time (DRT) with the time for one complete actual revolution (RT). If RT>DRT, in step 222 the controller decrements the value of a control signal sent to the PWM circuit 128 of the controller 102. If RT<DRT, in step 224 the controller increments the value of the control signal sent to the PWM circuit 128 of the controller 102.

If RT=DRT, in step 226 the controller does not update the value of the control signal sent to the PWM circuit 128 of the controller 102.

In step 228, the controller commutates, or selects, an appropriate BLDC motor winding using motor position information provided by the Hall sensor. Depending on the output of the Hall sensor, either a low (L) or a high (H) winding corresponding either to the first stator winding 108 or to the second stator winding 112 is selected in step 228. In step 230, the low driver is selected to be turned on by a PWM signal. In step 232, the high driver is selected to be turned on a PWM signal.

The algorithm then returns to step 212 in which the analog-to-digital ADC circuit 126 of the controller 102 reads the VT voltage at terminal 124.

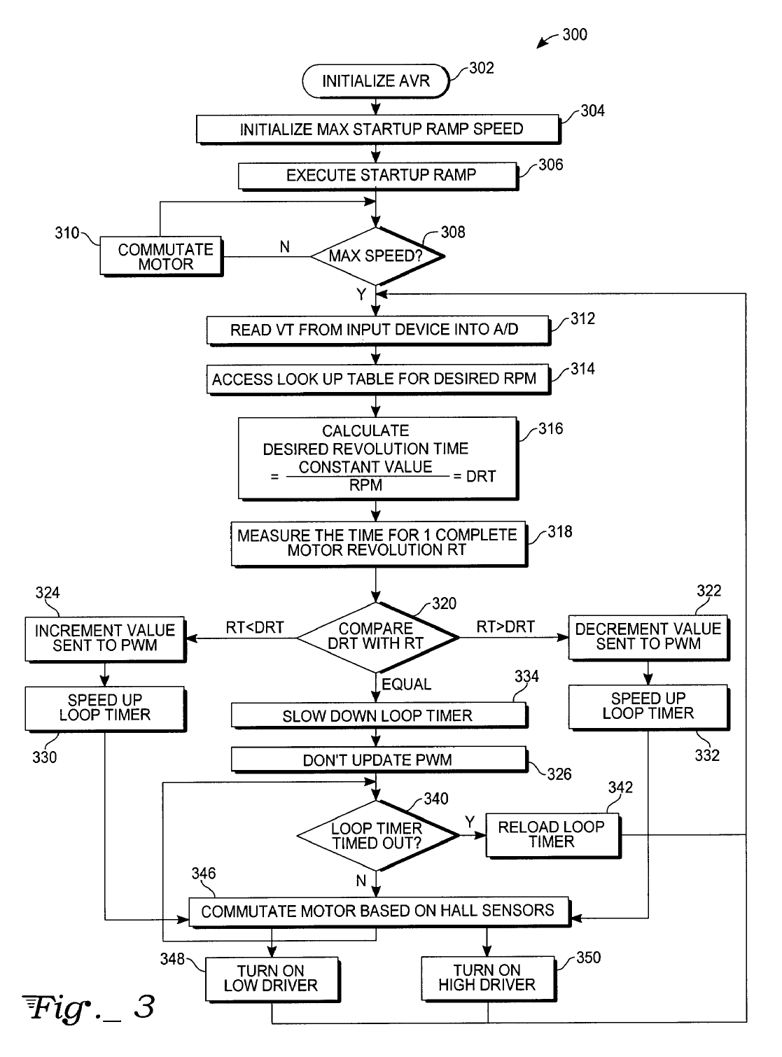

FIG. 3 illustrates a flow chart 300 for another embodiment of an algorithm illustrating various steps for controlling the speed of the BLDC motor system of FIG. 1. Similar functions are performed by similar elements described in connection with the embodiment of FIG. 2. In step 302, the controller, such as the exemplary AVR microcontroller, is initialized. In step 304, the maximum startup ramp speed is initialized; and in step 306, the algorithm executes a startup ramp for the BLDC motor. A decision step 308 determines whether the maximum startup speed has been reached. If the maximum startup speed is not been reached, step 310 calls for commutating the BLDC motor and returning to the decision block 308. If the maximum startup speed has been reached, in step 312 the analog-to-digital ADC circuit 126 of the controller 102 reads the VT voltage at terminal 124 corresponding to an ambient temperature. In step 314, the controller uses the digitized VT voltage to enter a lookup table that provides a desired RPM value for each digitized VT voltage value. The lookup table is used to match the speed of the BLDC motor to particular ambient temperature represented by the VT signal. In step 316, the controller calculates a desired revolution time (DRT) for a particular ambient temperature value by dividing a constant value by the desired RPM value of step 314.

In step 318, the controller measures the time for one complete actual revolution (RT) of the rotor by measuring the time for two Hall device output pulses. A 3-way decision step 320 compares the desired revolution time (DRT) with the time for one complete actual revolution (RT). If RT>DRT, in step 322 the controller decrements the value of a control signal sent to the PWM circuit 128 of the controller 102. If RT<DRT, in step 324 the controller increments the value of the control signal sent to the PWM circuit 128 of the controller 102.

If RT=DRT, in step 326 the controller does not update the value of the control signal sent to the PWM circuit 128 of the controller 102.

In this embodiment, a variable loop timer in the controller 102 adjusts the effective gain of the feedback loop at step 316a. This change in loop gain is effected in step 316a by changing the constant value. After step 324 increments the value of the control signal sent to the PWM circuit 128, step 230 speeds up the loop timer. After step 322 decrements the value of the control signal sent to the PWM circuit 128, step 232 speeds up the loop timer.

If step 320 determines the RT=DRT, step 234 slows down the loop timer and a following step 326 does not update the value of the control signal to the PWM circuit 128. A decision step 340 determines whether a loop timer has timed out. If yes, a step 342 reloads the loop timer and returns to the step 312. If the loop timer is not timed out, step 340 is followed by step 346 in which the controller 102 selects an appropriate BLDC motor winding using motor position information provided by the Hall sensor. The decrement step 322 and the increment step 324 also proceed to step 346. Step 346 goes to step 348 to turn on a low driver for one of the stator windings or step 350 to turn on a high driver for the other one of the stator windings. The algorithm return to step 312 in which the ADC circuit 126 reads the VT voltage at terminal 124 corresponding to an ambient temperature.

In step 346, the controller commutates, or selects, an appropriate BLDC motor winding using motor position information provided by the Hall sensor. Depending on the output of the Hall sensor, either the low (L) or the high (H) winding corresponding either to the first stator winding 108 or to the second stator winding 112.

The foregoing descriptions of specific embodiments of the present invention has been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of controlling a brushless direct current (BLDC) motor, the method comprising the steps of:
for a signal corresponding to an ambient temperature, providing a corresponding desired revolution per minute (RPM) value for the BLDC motor;
using a Hall device to measure an actual revolution time (RT) of the BLDC motor;
comparing DRT to RT and changing duration of a pulse width modulation (PWM) signal in response to the comparison; and
applying the PWM signal to one of two stator windings of a BLDC motor.

2. The method of claim 1 wherein the step of providing the corresponding desired revolution per minute (RPM) value includes using a digitized ambient temperature value to enter a lookup table.

3. The method of claim 2 including the lookup table providing a desired RPM value corresponding to each digitized temperature value to match the speed of the BLDC motor to a particular ambient temperature; and calculating a desired revolution time (DRT) of the BLDC motor for a particular ambient temperature value by dividing a constant value by the desired RPM value.

4. The method of claim 1 including measuring the time for one complete actual revolution (RT) of the rotor of the BLDC motor by measuring the time for Hall device output pulses.

5. The method of claim 1 including comparing the desired revolution time (DRT) with the time for one complete actual revolution (RT), and if RT>DRT, decrementing the value of a control signal sent to a PWM circuit and if RT<DRT, incrementing the value of the control signal sent to the PWM circuit.

6. The method of claim 1 including comparing the desired revolution time (DRT) with the time for one complete actual revolution (RT), such that if RT=DRT, the value of the control signal sent to the PWM circuit of the controller is not updated.

7. The method of claim 1 including commutating an appropriate BLDC motor winding using motor position information provided by the Hall device.

8. The method of claim 1 including commutating an appropriate BLDC motor winding using motor position information provided by the Hall device.

9. The method of claim 1 including applying the PWM signal to either a first driver circuit for a first stator winding or a second driver circuit for a second stator winding.

10. The method of claim 1 including executing a startup ramp for the BDLC motor and determining whether the maximum startup speed has been reached and, if not, commutating the BDLC.

11. A method of controlling a brushless direct current (BLDC) motor, the method comprising the steps of:
reading a VT voltage corresponding to an ambient temperature;
using a digitized VT voltage to access a lookup table that provides a corresponding desired RPM value for each digitized VT voltage value to match the speed of the BDLC motor to a particular ambient temperature represented by the VT signal;
calculating a desired revolution time (DRT) of a rotor of the BLDC motor for a particular ambient temperature value by dividing a constant value by the corresponding desired RPM value;
measuring a time for one complete actual revolution (RT) of the rotor of the BLDC motor by measuring a time for two Hall device output pulses;
comparing the desired revolution time (DRT) with the time for one complete actual revolution (RT), such that: if RT>DRT, decrementing the value of a control signal sent to a PWM circuit; if RT<DRT, incrementing the value of the control signal sent to the PWM circuit; if RT=DRT, not updating the value of the control signal sent to the PWM circuit of the controller;
commutating an appropriate BLDC motor winding using motor position information provided by the Hall device; and
applying a PWM signal to either a first driver circuit for a first stator winding or a second driver circuit for a second stator winding.

12. The method of claim 11 including the steps of:
executing a startup ramp for the BDLC motor; and
determining whether the maximum startup speed has been reached and, if not, commutating the BDLC motor and if so, proceeding the step of reading the VT voltage corresponding to an ambient temperature.

13. A brushless direct current (BLDC) motor system, comprising:
a first driver circuit for a first stator winding of a motor;
a second driver circuit for a second stator winding of a motor;
a Hall device that provides output signals corresponding to rotation of the motor;
a controller that receives an ambient temperature signal and the output signals of the Hall device and that provides pulse width modulated signals to the first and second stator windings of the motor wherein the width of said pulse width modulated signals are controlled to match a desired speed of the motor to the ambient temperature signal.

14. The system of claim 13 wherein the ambient temperature signal is digitized to provide a control value from a lookup table for the controller to match the desired motor speed to the ambient temperature.

15. The system of claim 14 wherein the controller compares a motor revolution time to a desired motor revolution time to provide adjustment to the width of said pulse width modulated signals.

16. The system of claim 14 wherein the lookup table provides a desired revolution time divisor that is divided into a constant value to provide a desired motor revolution time for a particular ambient temperature value.

17. The system of claim 15 wherein the controller commutates pulse width modulated signals to the driver circuits for the stator windings.

18. The system of claim 14 wherein the controller is a microcontroller.

19. A brushless direct current (BLDC) motor system, comprising:
a BLDC motor having a rotor with permanent magnets mounted thereto and having a stator with a first stator winding and a second stator winding;
a first driver circuit for the first stator winding and a second driver circuit for the second stator winding;
a Hall device that is fixed to the stator and that is configured to be activated by magnetic fields from the permanent magnets mounted to the rotor to provide Hall output pulses at an output terminal thereof;
a controller that has a Hall pulse input terminal configured to receive the Hall output pulses, that has a VT input terminal that is configured to receive a signal from a sensor for ambient temperature, that has a pulse width modulation (PWM) circuit for providing PWM signals to the first and the second driver circuits; and that has a commutator circuit for selecting either the first stator winding or the second stator winding;
wherein the controller is configured to digitize the VT voltage corresponding to an ambient temperature and to use a lookup table to provide a desired RPM value for each digitized VT voltage value in order to match the speed of the BDLC motor to a particular ambient temperature represented by the VT signal;
wherein the controller is configured to calculate a desired revolution time (DRT) for a particular ambient temperature value by dividing a constant value by the desired RPM value;
wherein the controller is configured to measure an actual time for one complete actual revolution (RT) of the rotor by measuring a time for two Hall device output pulses;
wherein the controller is configured to compare the desired revolution time (DRT) with the time for one complete actual revolution (RT) such that:
if RT>DRT, the controller is configured to decrement the value of a control signal sent to the PWM circuit; if RT<DRT, the controller is configured to increment the value of the control signal sent to the PWM circuit; and if RT=DRT, the controller is configured to not update the value of the control signal sent to the PWM circuit; and
wherein the controller is configured to commutate an appropriate BDLC motor winding using motor position information provided by the Hall sensor using either the first driver circuit for the first stator winding or the second driver circuit for the second stator winding.

20. The motor system of claim 19 wherein actual times are measured by counting a reference clock signal.
